(19) United States
(12) Patent Application Publication
(10) Pub. No.: US 2026/0180964 A1
(43) Pub. Date: Jun. 25, 2026

(54) DISTRIBUTED ISSUANCE SYSTEM FOR SECURE CREDENTIALS

(71) Applicant: WAVELYNX TECHNOLOGIES, LLC, Broonfield, CO (US)

(72) Inventors: Matthew Conrad, Broomfield, CO (US); Joseph Vellella, Arvada, CO (US)

(21) Appl. No.: 18/989,058

(22) Filed: Dec. 20, 2024

(51) Int. Cl. H04L 9/40

(52) U.S. Cl. CPC H04L 63/062; H04L 63/0853

(57) ABSTRACT

Systems and methods involve approaches for generating credential data such as sets of keys for access cards. The sets of keys can be generated using a unique identification number and respective master keys. The sets of keys can be used with card readers to provide access to facilities. The master keys can be stored at a central server.

### TECHNICAL FIELD

Embodiments of the present disclosure relate to systems and methods for issuance of secure credentials such as access cards.

### BACKGROUND

Many facilities throughout the world utilize electronic access control. Secure credential solutions (e.g., access cards, badges, and the like) are provided for access control and other applications. A card issuer can provide access cards or badges to employees. Security credential data can be encoded onto the access cards, and various security protocols can be implemented to protect the credential data.

### SUMMARY

In certain embodiments, systems and methods include approaches involving a credential-data-issuing process and an access-card-enrollment process. The credential-data-issuing process includes generating sets of keys for access cards. Each key can be generated based on a master key (e.g., symmetric key) and a unique identification number such as a serial number. The access-card-enrollment process includes providing access to customers to a manifest of credential data for ready-to-be enrolled access cards. The manifest can be accessed (e.g., using a link, QR code, and the like) to quickly retrieve a batch of credential data.

In certain embodiments, systems and methods involve approaches for generating credential data such as sets of keys for access cards. The sets of keys can be generated using one or more unique identification numbers and respective master keys (e.g., symmetric keys). The sets of keys can be recognized by card readers to provide access to facilities (e.g., to unlock a door). The master keys can be stored at a central server. In certain instances, the master keys are not transmitted to manufacturers or customers.

In certain embodiments, a method includes receiving, by a server, an initial request from a card manufacturer to issue credential data for access cards; generating, by the server, a set of keys for each of the access cards based on a unique identification number and a master key; and transmitting the set of keys to the card manufacturer. The set of keys can be considered to be credential data.

While multiple embodiments are disclosed, still other embodiments of the present disclosure will become apparent to those skilled in the art from the following detailed description, which shows and describes illustrative embodiments of the disclosure. Accordingly, the drawings and detailed description are to be regarded as illustrative in nature and not restrictive.

### BRIEF DESCRIPTION OF THE DRAWINGS

FIG. 1 is a schematic illustration of an example credential manufacturing and distribution system, in accordance with certain embodiments of the present disclosure.

FIG. 2 is a schematic illustration of an example credential issuance system, in accordance with certain embodiments of the present disclosure.

FIG. 3 shows a block diagram of an example method, in accordance with certain embodiments of the present disclosure.

FIG. 4 is a block diagram depicting an illustrative computing device, in accordance with instances of the disclosure.

While the disclosed subject matter is amenable to various modifications and alternative forms, specific embodiments have been shown by way of example in the drawings and are described in detail below. The intention, however, is not to limit the disclosed subject matter to the particular embodiments described. On the contrary, the disclosed subject matter is intended to cover all modifications, equivalents, and alternatives falling within the scope of the disclosed subject matter as defined by the appended claims.

### DETAILED DESCRIPTION

A secure credential issuance system involves credentials (e.g., access cards, badges, and the like) that are manufactured, distributed, and issued securely. There is a need to maintain the integrity and uniqueness of security keys and identifiers (IDs) during manufacturing, distribution, and issuance of secure credentials. Typically, methods and systems for issuing secure credentials often require sharing sensitive key information with multiple manufacturers, increasing the risk of security breaches and duplicate identifiers.

Certain embodiments of the present disclosure are directed to systems and methods for manufacturing, distributing, and issuing secure credentials. In some embodiments, systems and methods described herein help enable globally distributed manufacturing of secure credentials while centralizing key management and unique identifier generation. In some embodiments, the systems and methods can reduce the need to share secure keys with credential manufacturers by utilizing a centralized server for data processing, calculation, and/or distribution. In some embodiments, the systems and methods not only enhance security but can also mitigate the risk of generating duplicate identifiers across different credential manufacturers.

### Credential Manufacturing and Distribution System

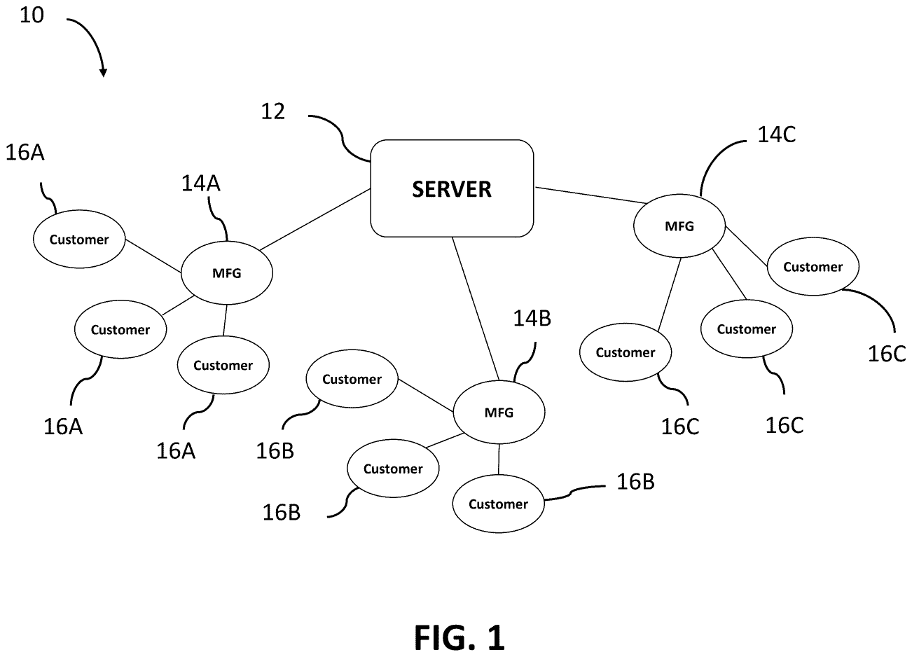

FIG. 1 shows a secure credential manufacturing and distribution system 10 (hereinafter “the system 10” for brevity) with schematic representations of parties/components that involve manufacturing and distributing secure credentials. In particular, the system 10 assists with globally distributed manufacturing of secure credentials while centralizing key management and unique identifier generation.

Server 12 receives an initial request from one of card manufacturers 14A, 14B, and 14C to issue credential data for access cards. An access card described herein may include, for example, a smart card, a proximity card (e.g., based on Radio Frequency Identification or RFID technology), a magnetic strip card, a Near Field Communication (NFC) card, and the like. An access card may also be a virtual card provided on a mobile device such as, for example, a cellphone. In certain embodiments, the access card is designed to utilize MIFARE® DESFire® EV3 technology from NXP Semiconductors.

The card manufacturer requests the server 12 to issue credential data for a batch of access cards to be distributed to different customers 16A, 16B, or 16C. For example, the card manufacturer 14A, 14B, or 14C can submit a request to the server 12 to issue credential data for access cards for their respective customers 16A, 16B, or 16C. In certain embodiments, the request from the card manufacturer includes a unique number such as a serial number (e.g., credential serial number) for each card in the batch of access cards to be manufactured.

A customer can be, for example, a card issuer company that issues the access cards to card holders or users. For example, a customer may be a company which issues access cards to its employees to access company facilities. While three card manufacturers are illustrated in FIG. 1, it is to be understood that the server 12 can provide service for other numbers of card manufacturers. While three customers are illustrated in FIG. 1 for each card manufacturer, it is to be understood that a card manufacturer can distribute access cards to other numbers of customers.

In certain embodiments, only preapproved manufacturers can send a request for credential data. For example, only preapproved manufacturers may receive access tokens that provide access to the server 12. As such, to send a request to the server 12 for credential data, the card manufacturers 14A-C can use a token to access the server 12 so that the card manufacturers 14A-C can be authenticated by the server 12. Put another way, the card manufacturers 14A-C authenticate with the server 12 using their access token.

In response to the initial request from the manufacturers, the server 12 generates credential data for each of the access cards. In some embodiments, the credential data includes one or more unique identification numbers for each of the access cards issued by the server 12. The unique identification numbers can be globally unique across all the card manufacturers 14A-C and the customers 16A-C. The unique identification numbers can be independent from each other. In other words, each access card generated by the server 12 has a unique identification number which may not be related to or derived from each other (e.g., not issued sequentially).

In some embodiments, when the server 12 receives the initial request from a card manufacturer to issue credential data for a batch of access cards, the server 12 responds by selecting a list of random identification numbers (from a pool of identification numbers not already issued/selected) for the batch of access cards such that each access card has a unique identification number generated by the server 12.

In some embodiments, the unique identification number can be a random value pre-generated by the server 12. The random values each can be, for example, a 12-digit number. The generated identification numbers can be randomly assigned to each of the access cards (e.g., not generated sequentially or in sequential batches).

In some embodiments, each access card can have a card number such as a number printed on a card surface that is different from the unique identification numbers. The card numbers (e.g., not the unique identification numbers) can be sequential numbers designated by a card manufacturer. For example, a batch of access cards may form a group and have respective sequential card numbers, while each access card is associated with a unique identification number which can be a random value. As such, each access card can be assigned a card number that is printed on a card surface and a unique identification number which is not printed on the card surface and, instead, is stored to memory inside the access card.

In some embodiments, the credential data for an access card includes a set of keys (e.g., read keys) associated with the access card. The set of keys can include a dual set of read keys such as a set of universal read keys and a set of customizable read keys. The set of universal read keys can be associated with a universal ID application. The set of universal read keys may have, for example, 16 read keys. In certain instances, the universal read keys are comprised of two sets of 8 read keys. The set of customizable read keys can be associated with a customized ID application. The set of customizable read keys may have, for example, 8 read keys. In certain embodiments, the set of customizable read keys are initially set to zero to allow the customizable read keys to be rewritten by a manufacturer or customer. It is to be understood that a set of read keys may have other numbers of keys.

Each individual read key can be generated based on (1) the unique identification number assigned to a respective access card (such as the serial number included in the request from the card manufacturer) and (2) a respective master key such as a respective symmetric key stored on the server 12. For example, each individual read key can be created by generating a hashed version of the respective master key using the unique identification number. As a more specific example, if eight read keys are used, eight different master keys (e.g., eight different symmetric keys) are used to generate the eight read keys.

As a result, the hashed versions (e.g., diversified versions) of the respective master keys—instead of the master keys stored at the server 12—are communicated to the manufacturers 14A-C or customers 16A-C. This approach reduces the risk of compromising the security of master keys. For example, if an individual access card's read key(s) were hacked, this would only affect the individual access card. In certain instances, the individual read keys can be referred to as diversified keys.

In some embodiments, in a universal ID application, the server 12 generates a universal ID for each access card. The universal ID can be a combination of the read keys generated based on the unique identification number assigned to a respective access card and a master key.

A standard card reader can be provided to read the universal ID which is encoded to the access card by using the universal read keys. The standard card reader can be positioned at common areas of a facility (e.g., a parking lot entrance, a cafeteria entrance, and the like) which may be shared with different customers (e.g., different tenants of a facility such as an office building).

With credential data being generated for each access card, the server 12 then transmits the generated credential data to a card manufacturer 14A-C for manufacturing a batch of access cards. When the access cards are distributed to the customers 16A-C, the rest of the card memory can be accessible and may be utilized for other applications. For example, the card memory can be programmed to be used with a customer's payment system (e.g., cafeteria), ticket system (e.g., sports game tickets).

The card manufacturers 14A-C encode access cards with the credential data. For example, the credential data can be loaded onto memory of an access card via an interface (e.g., an RFID interface). The card manufacturers 14A-C can then communicate with the server 12 to provide notification of which credential data was used to encode access cards. In certain instances, this notification involves sending the server 12 confirmed credential data (e.g., credential data associated with encoded access cards). In some embodiments, the confirmed credential data includes more than just the initial credential data transmitted to the card manufacturers 14A-C. For example, the confirmed credential data can include additional data loaded onto the memory by the card manufacturers 14A-C. As another example, the confirmed credential data can include data about the card manufacturer and the order number.

Because not all credential data initially sent to a card manufacturer may be used (e.g., because of issues with encoding a subset of access cards) or because the credential data may be used in stages (e.g., by encoding the credential data to a first batch of access cards and later encoding the credential data to a second batch of access cards), transmitting the confirmed credential data can inform the server 12 which credential data is associated with an access card and ready for enrollment of the access card.

The card manufacturers 14A-C distribute the manufactured access cards to their respective customers 16A-C. The customers 16A-C can then enroll the received access cards into, for example, a local access control system/platform. In some embodiments, one or more enrollment aids can be distributed along with the access cards to the customers 16A-C. The enrollment aids can include, for example, a link, a QR code, and the like. The customers 16A-C can send a request to the server 12 to obtain the credential data for each access card by using the enrollment aids. For example, the request from the customers can be initiated in response to the customers selecting a link or scanning a QR code.

In some embodiments, upon receiving the request from the customers 16A-C, the server 12 provides access to the credential data for the associated access cards and transmits the retrieved credential data to the customers.

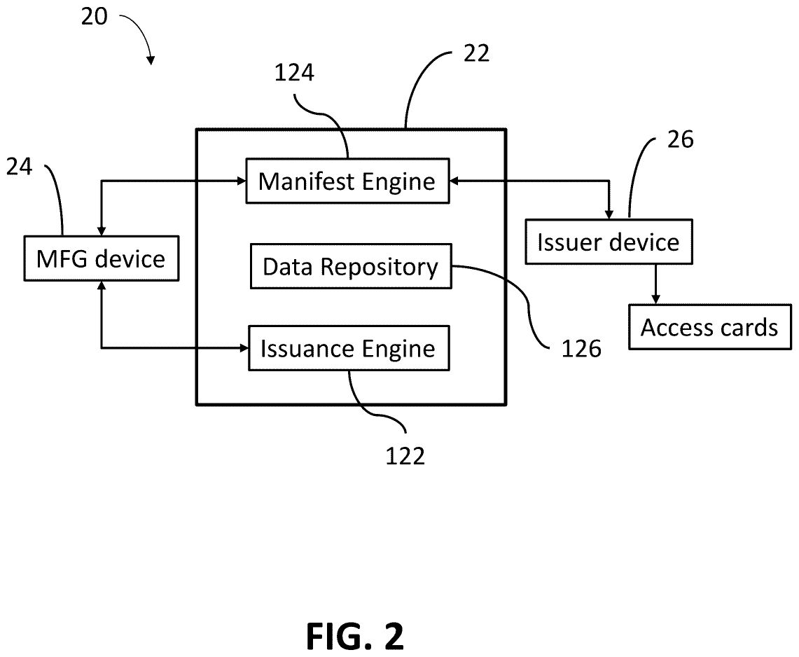

FIG. 2 shows a secure credential issuance system 20 (hereinafter “the system 20” for brevity) with schematic representations of parties/components that involve issuing credential data, among other things. In particular, the system 20 helps enable global distribution of secure credentials while centralizing key management and unique identifier generation. According to some embodiments, the system 20 includes a server 22 which is connected to a first client device 24 and a second client device 26 by a communication network. The server 22 and the devices 24 and 26 each may include one or more communication connections allowing communications with each other and with other computing devices. Examples of suitable communication connections include, but are not limited to, radio frequency (RF) transmitter, receiver, and/or transceiver circuitry, universal serial bus (USB), parallel, and/or serial ports.

In some embodiments, each of the server 22 and the devices 24 and 26 can be any suitable computing device or combination of devices, such as a desktop computer, a mobile computing device (e.g., a laptop computer, a smartphone, a tablet computer, a wearable computer, and the like), a server computer, a virtual machine being executed by a physical computing device, a web server, and the like. In some embodiments, each of the server 22 and the devices 24 and 26 can include a communication system to communicate data with each other over a communication network.

According to certain embodiments, the server 22 includes an issuance engine 122 configured to generate credential data for each access card in response to a request from the first client device 24. In some embodiments, the server 22 further includes a manifest engine 124 configured to store the credential data in a data repository 126 and retrieve the credential data from the data repository 126 in response to a request from the second client device 26. While a single server 22 is illustrated in FIG. 2, it is to be understood that, in some embodiments, the system 20 may include multiple servers. For example, the issuance engine 122 and the manifest engine 124 may be included in different servers that are able to communicate with each other.

In some embodiments, the first client device 24 can be a computing device of one of the card manufacturers 14A-C (FIG. 1) and may be referred to as a card manufacturer device (“MFG device”). The second client device 26 can be a computing device of one of the customers or card issuers 16A-C (FIG. 1) and may be referred to as a card issuer device (“issuer device”).

According to certain embodiments, the secure credential issuance system 20 can further include one or more Application Programming Interfaces (APIs) configured to facilitate communication between the server 22 and the first client device 24 and between the server 22 and the second client device 26. For example, the second client device 26 may implement a local access control system/platform which can communicate with the manifest engine 124 of the server 22 via one or more APIs.

The first client device 24 transmits an initial request to the server 22 to generate credential data. The initial request can include a unique identification number such as a serial number for each access card in which credential data is being requested.

In response to the initial request, the issuance engine 124 of the server 22 generates credential data (e.g., another one or more unique identification numbers, read keys) for each of the access cards, as described herein.

The server 22 transmits the credential data to the first client device 24. The credential data can be loaded onto access cards. Each access card can include memory and a communication interface. In certain embodiments, the communication interface is an RFID interface, and the credential data is loaded onto the memory via the RFID interface.

The confirmed credential data (as described herein) is transmitted from the first client device 24 to the server 22. The manifest engine 122 of the server 22 can receive the confirmed credential data and store it in the data repository 126 of the server 22. In some embodiments, the manifest engine 122 can concatenate the received credential data for the batch of access cards into a group of credential data and store the group of credential data in the data repository 126 to represent a group of credentials (e.g., a card pack or a card order).

When the server 22 receives a request from a second client device 26 for enrollment of the access cards, the manifest engine 122 can process the request and provide the corresponding credential data for the access cards. In some embodiments, the request from the second client device 26 is initiated in response to a customer 16A-C (FIG. 1) selecting a link or scanning a QR code.

In some embodiments, a batch of access cards delivered to the customer 16A-C (FIG. 1) may be provided with an enrollment aid. The enrollment aid can include, for example, a QR code, a URL, a shortened URL, and the like. It is to be understood that the enrollment aid may be provided in other suitable formats or manners. The manifest engine 122 can be accessed by the second client device 26 by using the enrollment aid. The second client device 26 can be, for example, a mobile device or a computing device such as a laptop, a mobile phone, a desktop computer, and the like. The customer 16A-C (FIG. 1) can detect the enrollment aid by using a detecting device associated with the second client device 26 (e.g., a smartphone, a tablet, a QR reader device, an NFC-enabled device, and the like) to obtain information associated with the batch of access cards. It is to be understood that the detecting device may be a separate device functionally connected to the second client device 26. In certain instances, the enrollment aid results in sending a communication to the server 22, and the communication can include the unique identification number (or other value) associated with each access card to be enrolled.

In response, the server 22 can transmit credential data so that the customer 16A-C can enroll the access cards for use with the access control device(s) used at their facilities.

Simply put, the process allows a customer to receive a box of access cards, scan a QR code (click a link, etc.), and enroll access cards. This process simplifies the enrollment process.

### Methods

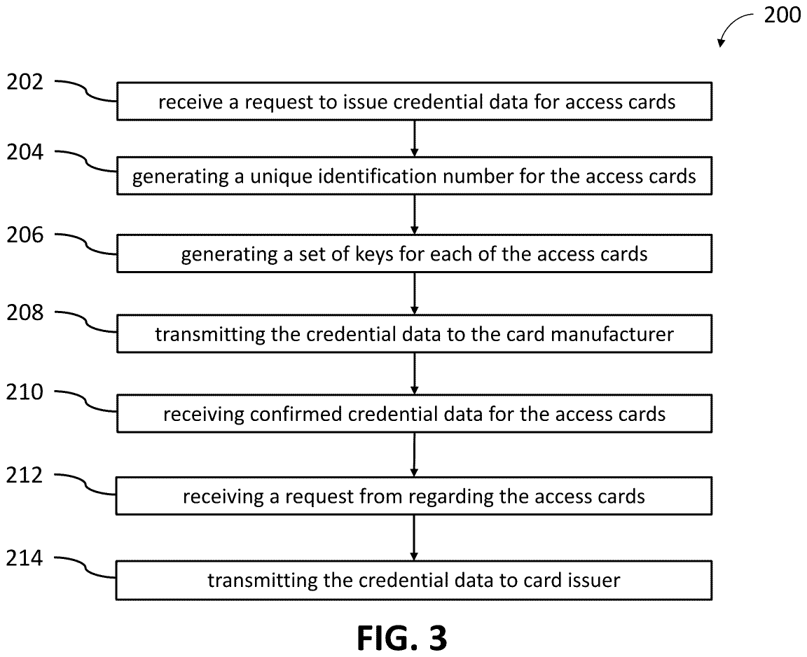

FIG. 3 is an example block diagram depicting an illustrative method 200 of manufacturing, distributing, and/or issuing credentials, in accordance with some embodiments of the present disclosure. Aspects of embodiments of the method 200 can be performed, for example the system 10 of FIG. 1 and/or the system 20 of FIG. 2 or other systems or components of the systems described herein. One or more steps or blocks of method 200 are optional and/or can be modified by one or more steps of other embodiments described herein. Additionally, one or more steps or blocks of other embodiments described herein may be added to the method 200.

Block 202-208 can be considered to be part of a credential-data-issuing process while blocks 212-214 can be considered to be part of an access-card-enrollment process.

The method 200 includes receiving, by a server, an initial request from a card manufacturer to issue credential data for access cards (block 202 in FIG. 3). The initial request can include a unique identification number for each of the access cards, and this unique identification number can be generated by the card manufacturer.

The method 200 further includes generating, by the server, one or more additional unique identification numbers for each of the access cards (block 204 in FIG. 3). The method 200 further includes generating, by the server, a set of keys for each of the access cards based on the manufacturer-generated unique identification number and a master key (block 206 in FIG. 3). The method 200 further includes transmitting the unique identification number and the set of keys to the card manufacturer (block 208 in FIG. 3).

The method 200 further includes receiving from the card manufacturer confirmed credential data for the access cards (block 210 in FIG. 3). The method 200 further includes receiving a request from a card issuer regarding the access cards (block 212 in FIG. 3). The method 200 further includes transmitting at least a subset of the credential data to the card issuer (block 214 in FIG. 3).

### Computing Devices and Systems

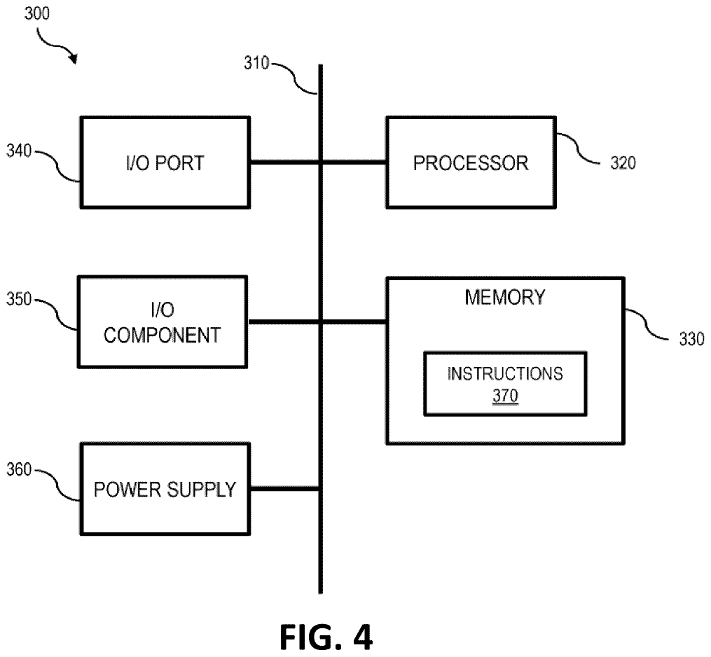

FIG. 4 is a block diagram depicting an illustrative computing device 300, in accordance with instances of the disclosure. The computing device 300 may include any type of computing device suitable for implementing aspects of instances of the disclosed subject matter. Examples of computing devices include specialized computing devices or general-purpose computing devices such as workstations, servers, laptops, desktops, tablet computers, hand-held devices, smartphones, general-purpose graphics processing units (GPGPUs), and the like. Each of the various components shown and described in the Figures can contain their own dedicated set of computing device components shown in FIG. 4 and described below. For example, the servers and client devices referred to herein can each include their own set of components shown in FIG. 4 and described below.

In certain instances, the computing device 300 includes a bus 310 that, directly and/or indirectly, couples one or more of the following devices: a processor 320, a memory 330, an input/output (I/O) port 340, an I/O component 350, and a power supply 360. Any number of additional components, different components, and/or combinations of components may also be included in the computing device 300.

The bus 310 represents what may be one or more busses (such as, for example, an address bus, data bus, or combination thereof). Similarly, in instances, the computing device 300 may include a number of processors 320, a number of memory components 330, a number of I/O ports 340, a number of I/O components 350, and/or a number of power supplies 360. Additionally, any number of these components, or combinations thereof, may be distributed and/or duplicated across a number of computing devices.

In certain instances, the memory 330 includes computer-readable media in the form of volatile and/or nonvolatile memory and may be removable, nonremovable, or a combination thereof. Media examples include random access memory (RAM); read only memory (ROM); electronically erasable programmable read only memory (EEPROM); flash memory; optical or holographic media; magnetic cassettes, magnetic tape, magnetic disk storage or other magnetic storage devices; data transmissions; and/or any other medium that can be used to store information and can be accessed by a computing device. In instances, the memory 330 stores computer-executable instructions 370 for causing the processor 320 to implement aspects of instances of components discussed herein and/or to perform aspects of instances of methods and procedures discussed herein. The memory 330 can comprise a non-transitory computer readable medium storing the computer-executable instructions 370.

The computer-executable instructions 370 may include, for example, computer code, machine-useable instructions, and the like such as, for example, program components capable of being executed by one or more processors 320 (e.g., microprocessors) associated with the computing device 300. Program components may be programmed using any number of different programming environments, including various languages, development kits, frameworks, and/or the like. Some or all of the functionality contemplated herein may also, or alternatively, be implemented in hardware and/or firmware.

According to instances, for example, the instructions 370 may be configured to be executed by the processor 320 and, upon execution, to cause the processor 320 to perform certain processes. In certain instances, the processor 320, memory 330, and instructions 370 are part of a controller such as an application specific integrated circuit (ASIC), field-programmable gate array (FPGA), and/or the like. Such devices can be used to carry out the functions and steps described herein.

The I/O component 350 may include a presentation component configured to present information to a user such as, for example, a display device, a speaker, a printing device, and/or the like, and/or an input component such as, for example, a microphone, a joystick, a satellite dish, a scanner, a printer, a wireless device, a keyboard, a pen, a voice input device, a touch input device, a touch-screen device, an interactive display device, a mouse, and/or the like.

The devices and systems described herein can be communicatively coupled via a network, which may include a local area network (LAN), a wide area network (WAN), a cellular data network, via the internet using an internet service provider, and the like.

Aspects of the present disclosure are described with reference to flowchart illustrations and/or block diagrams of methods, devices, systems and computer program products. It will be understood that each block of the flowchart illustrations and/or block diagrams, and combinations of blocks in the flowchart illustrations and/or block diagrams, can be implemented by computer program instructions.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

We claim:

1. A method comprising:
receiving, by a server, an initial request from a card manufacturer to issue credential data for access cards;
generating, by the server, a set of keys for each of the access cards based on a unique identification number and a master key; and
transmitting the unique identification number and the set of keys to the card manufacturer.

2. The method of claim 1, wherein the unique identification number includes values generated by the card manufacturer.

3. The method of claim 1, wherein each of the keys is a hashed version of the master key and the unique identification number.

4. The method of claim 1, wherein the keys include a set of universal read keys and a set of customizable read keys.

5. The method of claim 1, wherein the master key is a symmetric key.

6. The method of claim 1, wherein the set of keys for each of the access cards includes 8-16 individual keys.

7. The method of claim 1, further comprising:
receiving from the card manufacturer confirmed credential data for the access cards.

8. The method of claim 7, further comprising:
receiving a request from a card issuer regarding the access cards; and
transmitting at least a subset of the credential data to the card issuer.

9. The method of claim 8, wherein the request from the card issuer is initiated in response to the card issuer selecting a link or scanning a code.

10. A card issuance system comprising:
memory having instructions stored thereon; and
one or more processors configured to execute the instructions and perform operations comprising:
receiving an initial request from a card manufacturer for credential data;
generating a set of keys for each of the access cards based on the unique identification number and a master key; and
transmitting the unique identification number and the set of keys to the card manufacturer.

11. The system of claim 10, wherein the unique identification number is a value generated by the card manufacturer.

12. The system of claim 10, wherein each of the keys is a hashed version of the master key and the unique identification number.

13. The system of claim 10, wherein the keys include a set of universal read keys and a set of customizable read keys.

14. The system of claim 10, wherein the master key is a symmetric key.

15. The system of claim 10, wherein the set of keys for each of the access cards includes 8-16 individual keys.

16. The system of claim 10, wherein the operations further comprise:
receiving from the card manufacturer confirmed credential data for the access cards.

17. The system of claim 16, wherein the operations further comprise:
receiving a request from a card issuer regarding the access cards; and
transmitting at least a subset of the credential data to the card issuer.

18. The system of claim 17, wherein the request from the card issuer is initiated in response to the card issuer selecting a link or scanning a code.
